(19) United States
(12) Patent Application Publication
(10) Pub. No.: US 2015/0051918 A1
(43) Pub. Date: Feb. 19, 2015

(54) COMPUTER-BASED SYSTEM AND METHOD FOR PRESENTING CUSTOMIZED MEDICAL INFORMATION

(71) Applicant: Xerox Corporation, Norwalk, CT (US)

(72) Inventors: Michael P. Kehoe, Rochester, NY (US); Stuart Schweid, Pittsford, NY (US); Lee Anne Williams, Pittsford, NY (US); Robert P. Loce, Webster, NY (US); Beilei Xu, Penfield, NY (US)

(73) Assignee: Xerox Corporation, Norwalk, CT (US)

(21) Appl. No.: 13/966,879

(22) Filed: Aug. 14, 2013

(51) Int. Cl. G06F 19/00

(52) U.S. Cl. CPC G06F 19/322
USPC 705/3

(57) ABSTRACT

A computer-based method for presenting customized medical information, including: storing, in at least one memory element of at least one computer, computer readable instructions; and executing, using at least one processor for the at least one computer, the computer readable instructions to: receive an input identifying a patient; access electronic medical-related records (EMRRs) for the patient; formulate, based on data in the EMRRs, a query requesting information/input from the patient; transmit the query for display on a first graphical user interface (GUI) device; receive, in response to the query, an input providing the information/input; generate a video including at least one video segment related to the information/input; and transmit the video for display on the first GUI device or on a second GUI device.

### TECHNICAL FIELD

The present disclosure relates to a system and method for automatically generating a customized video for a patient based on an interactive process with the patient including queries to gather pertinent information from the patient and to identify topics of concern to the patient. The interaction and video are based at least partly on personal information from an electronic medical record for the patient and are in compliance with applicable privacy laws. The video is presented to the patient during an otherwise idle period, for example, waiting in an examination room, of a visit with a healthcare provider.

### BACKGROUND

Typically, during the course of a patient visit to a healthcare provider's office or other medical facility, the patient spends a significant amount of time waiting to be seen by a healthcare provider. For example, the patient is left in an examination room. The waiting time spent by the patient is a source of anxiety and frustration for the patient and does not contribute to the overall care of the patient. Healthcare providers have a limited amount of time to spend with each patient given current insurance guidelines and reimbursement processes. Thus, there is limited time to listen to, diagnose, and deliver information to the patient. Further, healthcare providers commonly find that patients are ill-informed and/or have not complied with medical regimens, which impedes successful outcomes for the patient and adds to the overall cost of treating the patient.

### SUMMARY

According to aspects illustrated herein, there is provided a computer-based method for presenting customized medical information, including: storing, in at least one memory element of at least one computer, computer readable instructions; and executing, using at least one processor for the at least one computer, the computer readable instructions to: receive an input identifying a patient; access an electronic medical-related records (EMRRs) for the patient; formulate, based on data in the EMRRs, a query requesting information/input from the patient; transmit the query for display on a first graphical user interface (GUI) device; receive, in response to the query, an input providing the information/input; generate a video including at least one video segment related to the information/input; and transmit the video for display on the first GUI device or on a second GUI device.

According to aspects illustrated herein, there is provided a computer-based apparatus for presenting customized medical information, including at least one computer, with at least one memory element configured to store computer readable instructions and at least one processor configured to execute the computer readable instructions to: receive ant input identifying a patient; access electronic medical-related records (EMRRs) for the patient; formulate, based on data in the EMRRs, a query requesting information/input from the patient; transmit the query for display on a first graphical user interface (GUI) device; receive, in response to the query, an input providing the information/input; generate a video including at least one video segment related to the information/input; and transmit the video for display on the first GUI device or on a second GUI device.

According to aspects illustrated herein, there is provided a computer-based method for presenting customized medical information, including: storing, in at least one memory element of at least one computer, computer readable instructions; and executing, using at least one processor for the at least one computer, the computer readable instructions to: receive an input identifying a patient; access electronic medical-related records (EMRRs) for the patient; formulate, based on data in the EMRRs, a query requesting information/input from the patient; transmit the query for display on a first graphical user interface (GUI) device; receive, in response to the query, an input providing the information/input; generate a video including at least one video segment related to the information/input; and transmit the video for display on the first GUI device or on a second GUI device. The information/input includes at least one of: compliance of the patient with a medical regimen; a symptom experienced by the patient; a medical topic the patient wishes to address in a current interaction with a healthcare provider; a request for information regarding insurance coverage for the patient; or a request for information related to a healthcare provider.

According to aspects illustrated herein, there is provided a computer-based method for presenting customized medical information, including: storing, in at least one memory element of at least one computer, computer readable instructions and executing, using at least one processor for the at least one computer, the computer readable instructions to: receive an input identifying a patient; access electronic medical-related records (EMRRs) for the patient; determine that a first graphical user interface (GUI) device is in a location in compliance with applicable legal requirements regarding confidentiality for the patient; formulate, based on data in the EMRRs, a query requesting information/input from the patient; formulate the query to be in compliance with the applicable legal requirements; transmit the query for display on the first GUI device; receive, in response to the query, an input providing the information/input; generate a video including at least one video segment related to the information/input; generate content of the at least one video segment to be in compliance with the applicable legal requirements and transmit the video for display on the first GUI device or on a second GUI device.

According to aspects illustrated herein, there is provided a computer-based apparatus for presenting customized medical information including at least one computer, including at least one memory element configured to store computer readable instructions and at least one processor configured to execute the computer readable instructions to: receive an input identifying a patient; access electronic medical-related records (EMRRs) for the patient; formulate, based on data in the EMRRs, a query requesting information/input from the patient; transmit the query for display on a first graphical user interface (GUI) device; receive, in response to the query, a second input providing the information/input; generate a video including at least one video segment related to the information/input; and transmit the video for display on the first GUI device or on a second GUI device. The at least one video segment includes at least one of: implications of or suggestions regarding the compliance of the patient with the first medical regimen; information or a query regarding the symptom experienced by the patient; information regarding the medical topic the patient wishes to address in the current interaction with a healthcare provider; a review of the patient's medical history; information regarding what to expect in the current office visit; or information regarding the insurance coverage for the patient.

According to aspects illustrated herein, there is provided a computer-based method for presenting customized medical information, including: storing, in at least one memory element of at least one computer, computer readable instructions; and executing, using at least one processor for the at least one computer, the computer readable instructions to: receive a first input identifying a patient; generate a video including at least one first video segment related to a first medical related topic and including first information not subject to legal requirements for patient confidentiality, or at least one second video segment related to a second medical related topic and including second information subject to legal requirements for patient confidentiality; and transmit the at least one first video segment for display on a first graphical user interface (GUI) device in a room not subject to legal requirements for patient confidentiality, or transmit the at least one first video segment or the at least one second video segment for display on a second GUI device in a room in compliance with legal requirements for patient confidentiality. The at least one computer is for a medical care entity. Generating the video includes receiving a second input from personnel of the medical care entity identifying the medical related topic or identifying the medical related topic in response to the patient's identity.

According to aspects illustrated herein, there is provided a computer-based apparatus for presenting customized medical information, including: at least one computer with at least one memory configured to store computer readable instructions and at least one processor configured to execute the computer readable instructions to: receive a first input identifying a patient; generate a video including at least one first video segment related to a first medical related topic and including first information not subject to legal requirements for patient confidentiality, or at least one second video segment related to a second medical related topic and including second information subject to legal requirements for patient confidentiality; and transmit the at least one first video segment for display on first graphical user interface (GUI) device in a room not subject to legal requirements for patient confidentiality, or transmit the at least one first video segment or the at least one second video segment for display on a second GUI device in a room in compliance with legal requirements for patient confidentiality. The at least one computer is for a medical care entity. Generating the video includes receiving a second input from personnel of the medical care entity identifying the medical related topic or identifying the medical related topic in response to the patient's identity.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic block diagram of a computer-based apparatus for presenting customized medical information.

### DETAILED DESCRIPTION

Moreover, although any methods, devices or materials similar or equivalent to those described herein can be used in the practice or testing of these embodiments, some embodiments of methods, devices, and materials are now described.

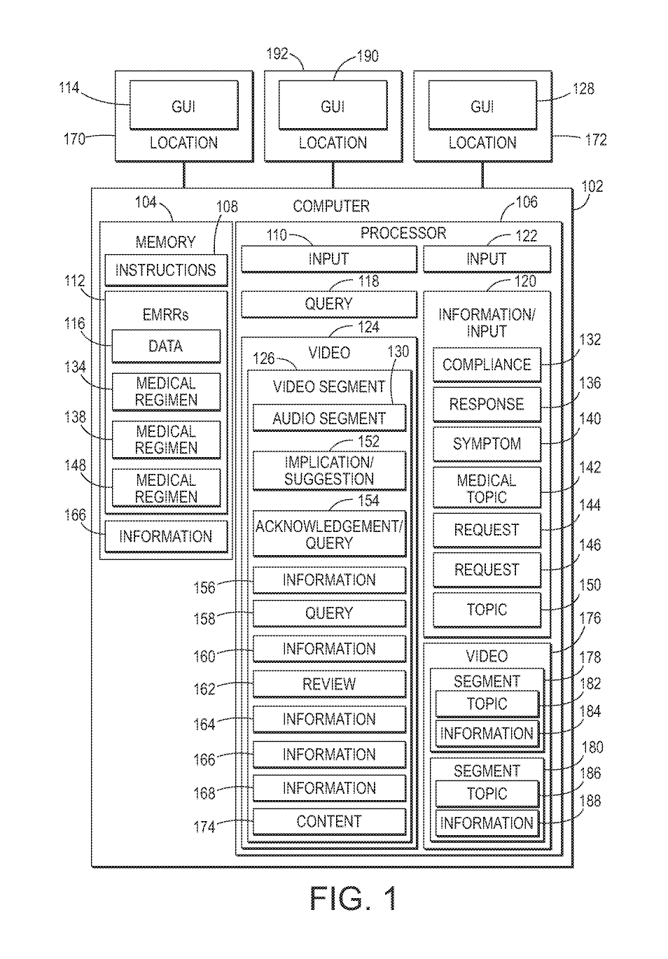

FIG. 1 is a schematic block diagram of computer-based apparatus 100 for presenting customized medical information. Apparatus 100 includes at least one computer 102 with at least one memory element 104, and at least one processor 106. The memory element is configured to store computer readable instructions 108. Processor 106 is configured to execute the computer readable instructions to receive input 110 identifying a patient and access electronic medical-related records (EMRRs) 112 for the patient. Input 110 can be provided directly by the patient using graphical user interface (GUI) device 114 or can be provided by the patient to medical personnel for inputting to computer 102. In an example embodiment, EMRRs 112 are stored in element 104; however, it should be understood that the EMRRs can be stored in a different memory element.

By “electronic medical-related records (EMRRs)” we mean some or all of an Electronic Medical Record (EMR), an Electronic Health Record (EHR), or a Personal Health Record (PHR). By “EMR” we mean a representation of most or all of a patient's medical data. An EMRRS can be of any type known in the art and can include text files, graphics/image files, audio files, and video files. An EMR captures and represents data that accurately reflects the state of the patient at all times. An EMR enables all or part of a patient's history to be viewed together, since elements constituting the history can be accessed from a single point of entry. Thus, an EMR enables effective and efficient extraction of medical data, for example, to examine of possible trends and long term changes in the patient. An EMR also may contain billing data, for example, to support insurance claims. An EMR is typically operated by medical practitioners or institutions, such as hospitals, and data in an EMR is typically entered by medical practitioners or other staff.

By “EHR we mean a systematic collection of electronic health information about individual patients or populations. An EHR is a record in digital format capable of being shared across different health care settings. In some cases this sharing can occur by way of network-connected enterprise-wide information systems and other information networks or exchanges. An EHR can include, but is not limited to, data including demographics, medical history, medication and allergies, immunization status, laboratory test results, radiology images, vital signs, personal statistics, such as age and weight, and billing information.

By “PHR” we mean a health record in which health data and information related to care of a patient is maintained by the patient. A PHR stands in contrast to an EMR, which is typically operated by medical practitioners or institutions, such as hospitals, and contains data entered by medical practitioners or other staff, or billing data to support insurance claims. A PHR provides a complete and accurate summary of an individual's medical history, for example, which is accessible online. The data in a PHR can include, but is not limited to, patient-reported outcome data, lab results, data from devices such as wireless electronic weighing scales, or data collected passively, for example, from a smartphone.

By “graphical user interface (GUI)” we mean an interface between a user and a computer system. By “GUI device” we mean computer hardware used to implement an interface between a user and a computer system, including, but not limited to a mouse, a keyboard, a touch screen, motion recognition systems, and audio recognition systems.

Hereinafter, it is understood that “processor 106 is configured to” is analogous to “processor 106 is configured to execute computer readable instructions 108 to”. Processor 106 is configured to formulate, based on input 110 and data 116 in the EMRRs, query 118. Query 118 requests response 120 from the patient. Processor 106 is configured to transmit query 118 for display on GUI device 114. Processor 106 is configured to receive, in response to query 118, input 122 providing response 120. Processor 106 is configured to generate video 124, including at least one video segment 126, based on input 124, and transmit video 124 for display on GUI device 114 or on GUI device 128 different from GUI device 114. For example, GUI device 114 can be in one portion of a medical office and GUI device 128 can be in a different portion of the medical office. In an example embodiment, processor 106 is configured to generate at least one audio segment 130 for video segment 126. Further detail regarding the creation of video segment 126 and audio segment 130 is provided in commonly owned U.S. patent application Ser. Nos. 13/893,753, 13/150,450, 13/150,462, and Ser. No. 13/484,627, which applications are incorporated in their entirety herein.

In an example embodiment, information/input 118 includes at least one of: compliance 132 of the patient with medical regimen 134; response 136 of the patient to medical regimen 138; symptom 140 experienced by the patient; medical topic 142 the patient wishes to address in a current interaction with a healthcare provider; request 144 for information regarding insurance coverage for the patient; or request 146 for information related to a healthcare provider. At least one of the preceding elements of information/input 118 is generated based on patient-specific information in EMRRs 112.

In an example embodiment, information 132 is based on medical regimen 134 included in EMRRs 112. Processor 106 is configured to access EMRRs 112, review regimen 134, identify cogent compliance aspects of regimen 134, and generate information 132 to incorporate the cogent compliance aspects. Cogent aspects could include taking a prescription at the prescribed times and dosages, following dietary restrictions, or complying with physical therapy or exercise programs. In an example embodiment, response 136 is based on medical regimen 138 included in EMRRs 112. Processor 106 is configured to access EMRRs 112, review regimen 138, and generate information 134 to elicit applicable responses from the patient regarding regimen 138, such as the patient's subjective response to or suggestions regarding regimen 138, or whether the patient has experienced positive results from a treatment or prescription.

Information 140 can identify likely or known symptoms associated with medical regimen 148 in EMRRs 112, can track previously identified symptoms from the EMRRs, or can address a new symptom. Candidates for topic 142 can be formulated based on information in the EMRRs, or on a topic already discussed with the healthcare provider and recorded in the EMRRs. Topic 142 also can be left open ended. Regarding information 144, query 118 can prompt the patient to consider the implications of their insurance coverage and ask questions regarding their coverage. Information 144 can identify the level of understanding a patient may have regarding insurance requirements and restrictions, which can help guide the healthcare provider during the examination of the patient.

In an example embodiment, information/input 118 includes topic 150 of interest to the patient and not otherwise addressed in the above aspects of information/input 118.

Video segment 126 is dynamically generated in response to input 122. In an example embodiment, video segment 126 includes at least one of: implication of or suggestion 152 regarding compliance 132 of the patient with medical regimen 134; acknowledgement 154 of response 136 or query 154 regarding response 136, for example, to elicit further information or detail regarding query 154; information 156 regarding symptom 140 or query 158 regarding symptom 140; information 160 regarding medical topic 142; review 162 of the patient's medical history from the EMRRs; information 164 as to what to expect in the current office visit; or information 166 regarding the insurance coverage for the patient. At least one of the preceding elements of segment 126 is generated based on patient-specific information in EMRRs 112.

Implications or suggestions 152 can help prepare the patient for the current visit by educating the patient as to the positive and negative affects of their compliance and can help minimize the time the healthcare provider will need to spend on the patient's compliance by providing information that would otherwise be provided by the healthcare provider. Also, implications or suggestions 152 can provide suggestions to help the patient improve compliance. Implications and suggestions 152 are not meant to replace input from the healthcare provider, but rather to facilitate the process.

Acknowledgement 154 ensures that response 136 is addressed by the healthcare provider. Response 136 can be correlated to regimen 138 and query 158 can be formulated based on regimen 138 to identify appropriate follow-up information. Based on data 116 or other available medical information, information 156 can provide helpful details regarding symptom 140, such as duration of the symptom, seriousness of the symptom, and means of avoiding or treating the symptom. Based on data 116 or other available medical information, query 158 can elicit additional information that the healthcare provider will find to be helpful if not necessary.

In an example embodiment, the processor receives input 167 including answers to query 154 and/or query 158. Input 167 is then used to update video segment 124.

In an example embodiment, based on data 116 or other available medical information, information 160 is generated to educate the patient regarding topic 142 to facilitate a discussion with the healthcare provider regarding topic 142. Review 162 and information 164 are based on data 116 and prepare the patient for the current office visit, alleviate anxiety the patient may feel about the current visit, and enable the patient to better absorb information presented during the visit and prepare questions to ask during the visit.

In an example embodiment, processor 106 is configured to access information 166 regarding the patient's healthcare insurance and data 116 in the EMRRs to correlate information 166 with data 116 to generate information 168 specific to a medical condition identified in data 116. Information 166 can be stored in memory 104 or processor 106 can access a different memory element storing information 166. In an example embodiment, information 168 is directed to medical conditions identified in the EMRRs, in particular medical conditions referenced in response 120 or to be addressed in the current visit and can include co-pay requirements or payment limitations and diagnostic or treatment options and limitations. As a result of information 168, the patient is better informed regarding their options, the healthcare provider does not need to spend as much time reviewing insurance issues with the patient and the healthcare provider is made aware of insurance implications.

In general, input 122 provides valuable information to prepare the healthcare provider for the current visit. The amount of time needed by the healthcare provider to gather data during the visit is greatly reduced, leaving more time for actual examination of and discussion with the patient, all of which leads to better outcomes for the patient.

Apparatus 100 operates in compliance with all applicable legal requirements, for example, the Health Insurance Portability and Accountability Act (HIPAA), regarding confidentiality of the patient as follows:

1. Transmitting query 118 for display on GUI device 114 includes transmitting query 118 for display on GUI device 114 only when GUI device 114 is in location 170 enabling the compliance noted above; or,

2. Transmitting video 124 for display on GUI device 114 includes transmitting video 124 for display on GUI device 114 only when GUI device 114 is in location 170; or,

3. Transmitting video 124 for display on GUI device 128 includes transmitting video 124 for display on GUI device 128 when GUI device 128 is in location 170 or in location 172, also enabling the compliance noted above.

In an example embodiment, processor 106 is configured to determine that GUI device 114 is in location 170, formulate query 118 to be in compliance with the applicable legal requirements, and, when video segment 126 is transmitted to GUI device 114, generate video segment 126 to be in compliance with the applicable legal requirements. That is, query 118 and content 174 of video segment 126 only include confidential information (as defined by the applicable legal requirements) for display on GUI device 114 when GUI device 114 is in a location in compliance with the applicable legal requirements.

In an example embodiment, processor 106 is configured to determine that GUI device 128 is in location 170 or location 172 and generate video segment 126 to be in compliance with the applicable legal requirements. That is, content 174 of video segment 126 only includes confidential information (as defined by the applicable legal requirements) for display on GUI device 128 when GUI device 128 is in a location in compliance with the applicable legal requirements.

In an example embodiment, processor 106 is configured to execute computer readable instructions 108 to receive input 110 and generate video 176 including video segment 178 or video segment 180. Segment 178 is related to medical related topic 182 and includes information 184 not subject to legal requirements for patient confidentiality. Segment 180 is related to medical related topic 186 and includes information 188 subject to legal requirements for patient confidentiality. The processor is configured to transmit video segment 178 for display on GUI device 190 in location 192 not subject to legal requirements for patient confidentiality. The processor is configured to transmit video segment 180 for display on GUI device 114 or 128. In an example embodiment, computer 102 is for a medical care entity, such as an office for a health care provider, a medical clinic, or a hospital. In an example embodiment, generating video 176 includes receiving input 192 from personnel of the medical care entity identifying medical related topic 182 or 186. In an example embodiment, processor 106 is configured to identify topic 182 or 186 in response to the patient's identity.

Any computer, memory element, and processor known in the art can be used for computer 102, memory element 104, and processor 106. Any GUI device known in the art can be used for GUI device 114 or GUI device 128. Any means known in the art can be used to accept input 122 including, but not limited to, a keyboard, touch screen, speech recognition, or gesture recognition.

The following provides further detail regarding apparatus 100. Apparatus 100 delivers customized and personalized video information to a patient, the content of which is selected at the time of a visit and is directed to matters pertaining to the patient and the current visit. In an example embodiment, video 124 is provided to the patient in a private setting during time that is otherwise currently wasted and a source of patient frustration. Apparatus 100 also collects information from the patient via voice, gesture, or other non-contact input methods in response to voice and/or video queries to the patient. The collected information may be used to further extend the personalized information presented to the patient and to inform the healthcare provider of patient concerns. Thus, time that is otherwise not put to productive use can be used to educate the patient on topics of interest such as, but not limited to: their medical history, insurance implications, and potential procedures. This gives the patient a better understanding of their situation and enables a more informed discussion with their caregiver leading to better outcomes.

As noted above, caregivers have a limited amount of time to spend with each patient, given current insurance guidelines and reimbursement processes, and consequently healthcare providers have limited time to listen, diagnose, and deliver information to the patient. Advantageously, apparatus 100 enables patients to ask questions, review information, provide information, and generally be better prepared to utilize their time with the healthcare provider.

Advantageously, apparatus 100 improves the cost/benefit ratio of healthcare visits by taking advantage of wait time, presently spent by patients, by providing patient education and also, potentially, collecting information on the patient's condition during that time. A better informed patient is more likely to:
1. Have a better, more focused, and more productive interaction with the healthcare provider in the short time allotted.
2. Ask more relevant questions regarding their diagnosis or prognosis, which leads to better outcomes for the patient.
3. Exhibit improved compliance with care instructions.
4. Have a higher satisfaction with the visit, both in terms of time productively spent and additional education received.
   Apparatus 100 also ensures (and provides a record) that a patient was informed of their condition and prognosis and other pertinent information.

Apparatus 100 delivers customized and personalized video information to the patient, the content of which is dynamically selected and generated at the time of visit and directed to matters pertaining to the patient and the current visit. Examples of information provided by apparatus 100 include:
1. Processes or procedures that will occur during the current visit.
2. Various diagnostic and treatment options.
3. FAQ (frequently asked questions) that others with similar conditions have wanted to know; this can both impart information and act as a prompt for questions in the upcoming visit with the healthcare provider.
4. Current condition and wellness recommendations.
5. Current/previous vitals measurement.
6. Care implication due to insurance coverage.
7. Symptom refinements or related symptom possibilities.
8. If the patient is new to the practice or the healthcare provider is new to the patient, an introduction of specialties/experience of the healthcare provider.

The following is an example scenario of the use of apparatus 100:
1. GUI device 114 is set up in a private exam/waiting room setting.
2. Input 110 identifying a patient is received on GUI device 114.
3. Query 118 is generated by computer 102 and presented on GUI device 114.
4. GUI device 114 receives input 122 including at least one topic of interest 142 or 150.
5. Computer 102 generates video 124 and presents video 124 on GUI device 114.

GUI device 114 or 128 can be located in a variety of locations, such as a nurse's station, an examination room, a treatment room, or a hospital room. Query 110 ensures that the patient is properly identified and that confidential information is not divulged to the wrong person. Further, once the patient is properly identified, more specific and personal information can be used to generate query 118 and video 124. For example, if a patient suffers from a particular medical condition, specific information regarding the patient's diagnosis, treatment, and prognosis can be provided rather than generic information regarding the condition. In an example embodiment, input 110 is taken by medical personnel, such as an office assistant, prior to placing the patient in an exam room and the office assistance inputs the information to computer 102. By “medical personnel” we mean personnel involved in operation of a facility in which apparatus 100 is being used. The term does not imply a level or medical training or competence. In an example embodiment, questions pertaining to input 110 are presented on GUI device 114, and the patient provides input 110 via GUI device 114. Any means known in the art can be used to confirm a patient's identify including documentation, such as a social security number, passwords, or biometrics such as speech recognition, facial recognition, or any bio-metric based identification system known in the art.

In an example embodiment, video 124 is made available for the patient to use after the current office visit.

The following is an example scenario of the use of apparatus 100:
1. The patient checks in and is identified.
2. The patient is brought to a private examination room to wait for a healthcare provider.
3. The patient begins interaction with apparatus 100 by using GUI device 114 to identify themselves using bio-metric data, such as facial or vein pattern recognition.
4. Query 118 is presented, for example, asking by voice or by text on GUI device 114 if the patient has been regularly exercising and taking the medication previously prescribed.
5. GUI device 114 accepts input 122 with answers to query 118. Any means known in the art can be used to accept input include a keyboard, touch screen, speech recognition, or gesture recognition.
6. Query 118 is presented in the form of a list of possible symptoms for diabetes and a request to list other symptoms currently experienced by the patient.
7. GUI a device 114 accepts input 122 identifying symptoms selected by the patient.
8. Using any means known in the art, apparatus 100 non-invasively and in a non-contact manner, collects current vital signs of the patient. As means known in the art can be used to collect the vital signs, including, but not limited to analyzing video images of the patient using simple webcams, infrared, multispectral, and/or hyper spectral camera, and extracting human vital signs such as pulse rate, respiration rate, oxygen saturation levels, and blood pressure and tidal volume measurements.
9. Apparatus 100 retrieves data 116 from EMRRs 112 including any relevant medical images/videos.
10. Apparatus 100 generates and displays on GUI 114, personalized video 124 directed to the patient's diabetes while the patient is waiting for the healthcare provider. Video 124 includes educational material as well as the actual values of various patient-specific parameters.
11. Following the current visit, apparatus 100 creates updated diabetes video 124 for the patient based on the data 116, a current condition of the patient, and on a new care plan developed by the healthcare provider.
12. Apparatus 100 emails to the patient a link to personalized video 124. The video reviews the patient's current measurements, list of symptoms and the effects of the diabetes, and amends the care plan prescribed the patient. The patient shares the video with her/his family, who will be helping the patient to maintain a healthier life, through the care plan.
13. Included in the email is a link that allows the patient or the patient's family to contact healthcare provider with any additional concerns or questions.

Advantageously, the presentation of video 124 in the waiting room answers common questions that the patient would otherwise asks the physician during a visit, leaving more time for other productive uses during the visit. Also, video 124 provides valuable background information to help the patient formulate detailed questions while awaiting the physician.

Apparatus is not limited to use in a healthcare provider's office or clinic. In an example embodiment, apparatus 100 is used in a hospital setting. For example, in-hospital patients stay in “smart rooms” where information is delivered, using touch screens for example, to the healthcare provider. This arrangement ensures that necessary medical information is available to the healthcare provider at the moment of patient interaction. Apparatus 100 is interfaced with this existing infrastructure. Thus, query 118, response 120, and video 124 can be used to interact with the patient to provide valuable information to the patient and valuable information for use by healthcare providers while the patient is in the room and a healthcare provider is not present.

In an example embodiment, apparatus 100 is used with waiting rooms with telemedicine robots or stations.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-based method for presenting customized medical information, comprising:
storing, in at least one memory element of at least one computer, computer readable instructions; and,
executing, using at least one processor for the at least one computer, the computer readable instructions to:
receive a first input identifying a patient;
access electronic medical-related records (EMRRs) for the patient;
formulate, based on data in the EMRRs, a first query requesting information/input from the patient;
transmit the first query for display on a first graphical user interface (GUI) device;
receive, in response to the first query, a second input providing the information/input;
generate a video including at least one video segment related to the information/input; and,
transmit the video for display on the first GUI device or on a second GUI device.

2. The computer-based method of claim 1, wherein the information/input includes at least one of:
compliance of the patient with a first medical regimen;
a symptom experienced by the patient;
a medical topic the patient wishes to address in a current interaction with a healthcare provider;
a request for information regarding insurance coverage for the patient; or,
a request for information related to a healthcare provider.

3. The computer-based method of claim 2, wherein the at least one video segment includes at least one of:
implications of or suggestions regarding the compliance of the patient with the medical regimen;
information regarding the symptom experienced by the patient or a query regarding the symptom experienced by the patient;
information regarding the medical topic the patient wishes to address in the current interaction with a healthcare provider,
a review of the patient's medical history;
information regarding what to expect in the current office visit; or,
information regarding the insurance coverage for the patient.

4. The computer-based method of claim 3, further comprising:
executing, using the at least one processor for the at least one computer, the computer readable instructions to:
correlate information related to the insurance coverage with information in the EMRRs to generate the information regarding the insurance coverage for the patient to be specific to a medical condition identified in the EMRRs.

5. The computer-based method of claim 3, wherein at least one of the following is based on information in the EMRRs for the patient:
the implications of or suggestions regarding the compliance of the patient with the first medical regimen;
the information regarding the symptom experienced by the patient or the query regarding the symptom experienced by the patient;
the information regarding the medical topic the patient wishes to address in the current interaction with a healthcare provider,
the information regarding what to expect in the current office visit; or,
the information regarding the insurance coverage for the patient.

6. The computer-based method of claim 1, wherein:
transmitting the first query for display on the first GUI device includes transmitting the first query for display on the first GUI device while the first GUI device is in a first location enabling confidentiality, in compliance with applicable legal requirements, for the patient; or,
transmitting the video for display on the first GUI device includes transmitting the video for display on the first GUI device while the first GUI device is in the first location; or,
transmitting the video for display on the second GUI includes transmitting the video for display on the second GUI device while the second GUI device is in the first location or is in a second location enabling confidentiality, in compliance with applicable legal requirements, for the patient.

7. The computer-based method of claim 1, further comprising:
executing, using the at least one processor for the at least one computer, the computer readable instructions to:
determine that the first GUI device is in a location in compliance with applicable legal requirements regarding confidentiality for the patient;
formulate the first query to be in compliance with the applicable legal requirements; and,
generate the at least one video segment to be in compliance with the applicable legal requirements.

8. The computer-based method of claim 1, further comprising:
executing, using at least one processor for the at least one computer, the computer readable instructions to:
determine that the second GUI device is in a location in compliance with applicable legal requirements regarding confidentiality for the patient; and,
generate the at least one video segment to be in compliance with the applicable legal requirements.

9. A computer-based apparatus for presenting customized medical information, comprising:
at least one computer, including:
at least one memory element configured to store computer readable instructions; and,
at least one processor configured to execute the computer readable instructions to:
receive a first input identifying a patient;
access electronic medical-related records (EMRRs) for the patient;
formulate, based on data in the EMRRs, a first query requesting information/input from the patient;
transmit the first query for display on a first graphical user interface (GUI) device;
receive, in response to the first query, a second input providing the information/input;
generate a video including at least one video segment related to the information/input; and,
transmit the video for display on the first GUI device or on a second GUI device.

10. The computer-based apparatus of claim 9, wherein the information/input includes at least one of:
compliance of the patient with a medical regimen;
a symptom experienced by the patient;
a medical topic the patient wishes to address in a current interaction with a healthcare provider;
a request for information regarding insurance coverage for the patient; or,
a request for information related to a healthcare provider.

11. The computer-based apparatus of claim 10, wherein the at least one video segment includes at least one of:
implications of or suggestions regarding the compliance of the patient with the medical regimen;
information regarding the symptom experienced by the patient or a query regarding the symptom experienced by the patient;
information regarding the medical topic the patient wishes to address in the current interaction with a healthcare provider,
a review of the patient's medical history;
information regarding what to expect in the current office visit; or,
information regarding the insurance coverage for the patient.

12. The computer-based apparatus of claim 11, wherein the at least one processor for the at least one computer is configured to execute the computer readable instructions to:
correlate information related to the insurance coverage with information in the EMRRs to generate the information regarding the insurance coverage for the patient to be specific to a medical condition identified in the EMRRs.

13. The computer-based apparatus of claim 11, wherein at least one of the following is based on information in the EMRRs for the patient:
the implications of or suggestions regarding the compliance of the patient with the first medical regimen;
the information regarding the symptom experienced by the patient or the query regarding the symptom experienced by the patient;
the information regarding the medical topic the patient wishes to address in the current interaction with a healthcare provider,
the information regarding what to expect in the current office visit; or,
the information regarding the insurance coverage for the patient.

14. The computer-based apparatus of claim 9:
transmitting the first query for display on the first GUI device includes transmitting the first query for display on the first GUI device while the first GUI device is in a first location enabling confidentiality, in compliance with applicable legal requirements, for the patient; or,
transmitting the video for display on the first GUI device includes transmitting the video for display on the first GUI device while the first GUI device is in the first location; or,
transmitting the video for display on the second GUI device includes transmitting the video for display on the second GUI device while the second GUI device is in the first location or is in a second location enabling confidentiality, in compliance with applicable legal requirements, for the patient.

15. The computer-based apparatus of claim 9, further comprising:
executing, using the at least one processor for the at least one computer, the computer readable instructions to:
determine that the first GUI device is in a location in compliance with applicable legal requirements regarding confidentiality for the patient;
formulate the first query to be in compliance with the applicable legal requirements; and,
generate the at least one video segment to be in compliance with the applicable legal requirements.

16. The computer-based apparatus of claim 9, further comprising:
executing, using at least one processor for the at least one computer, the computer readable instructions to:
determine that the second GUI device is in a location in compliance with applicable legal requirements regarding confidentiality for the patient; and,
generate the at least one video segment to be in compliance with the applicable legal requirements.

17. A computer-based method for presenting customized medical information, comprising:
storing, in at least one memory element of at least one computer, computer readable instructions; and,
executing, using at least one processor for the at least one computer, the computer readable instructions to:
receive a first input identifying a patient;
access electronic medical-related records (EMRRs) for the patient;
formulate, based on data in the EMRRs, a first query requesting information/input from the patient;
transmit the first query for display on a first graphical user interface (GUI) device;
receive, in response to the first query, a second input providing the information/input;
generate a video including at least one video segment related to the information/input; and,
transmit the video for display on the first GUI device or on a second GUI device, wherein:
the information/input includes at least one of:
compliance of the patient with a medical regimen;
a symptom experienced by the patient;
a medical topic the patient wishes to address in a current interaction with a healthcare provider;
a request for information regarding insurance coverage for the patient; or,
a request for information related to a healthcare provider.

18. A computer-based method for presenting customized medical information, comprising:
storing, in at least one memory element of at least one computer, computer readable instructions; and,
executing, using at least one processor for the at least one computer, the computer readable instructions to:
receive a first input identifying a patient;
access electronic medical-related records (EMRRs) for the patient;
determine that a first graphical user interface (GUI) device is in a location in compliance with applicable legal requirements regarding confidentiality for the patient;
formulate, based on data in the EMRRs, a first query requesting information/input from the patient;
formulate the first query to be in compliance with the applicable legal requirements;
transmit the first query for display on the first GUI device;
receive, in response to the first query, a second input providing the information/input;
generate a video including at least one video segment related to the information/input;
generate the at least one video segment to be in compliance with the applicable legal requirements and,
transmit the video for display on the first GUI device or on a second GUI device.

19. A computer-based apparatus for presenting customized medical information, comprising:
at least one computer, including:
at least one memory element configured to store computer readable instructions; and,
at least one processor configured to execute the computer readable instructions to:
receive a first input identifying a patient;
access electronic medical-related records (EMRRs) for the patient;
formulate, based on data in the EMRRs, a first query requesting information/input from the patient;
transmit the first query for display on a first graphical user interface (GUI) device;
receive, in response to the first query, a second input providing the information/input;
generate a video including at least one video segment related to the information/input; and,
transmit the video for display on the first GUI device or on a second GUI device, wherein:
the at least one video segment includes at least one of:
implications of or suggestions regarding the compliance of the patient with a medical regimen;
information or a query regarding a symptom experienced by the patient;
information regarding a medical topic the patient wishes to address in the current interaction with a healthcare provider,
a review of the patient's medical history;
information regarding what to expect in the current office visit; or,
information regarding the insurance coverage for the patient.

20. The computer-based apparatus of claim 19, wherein:
the at least one processor for the at least one computer is configured to execute the computer readable instructions to determine that the first GUI device is in a location in compliance with applicable legal requirements regarding confidentiality for the patient;
formulating the first query includes formulating the first query to be in compliance with the applicable legal requirements; and,
generating the video including generating the at least one video segment to be in compliance with the applicable legal requirements.

21. A computer-based method for presenting customized medical information, comprising:
storing, in at least one memory element of at least one computer, computer readable instructions; and,
executing, using at least one processor for the at least one computer, the computer readable instructions to:
receive a first input identifying a patient;
generate a video including:
at least one first video segment related to a first medical related topic and including first information not subject to legal requirements for patient confidentiality; or,
at least one second video segment related to a second medical related topic and including second information subject to legal requirements for patient confidentiality; and,
transmit the at least one first video segment for display on a first graphical user interface (GUI) device in a room not subject to legal requirements for patient confidentiality; or,
transmit the at least one first video segment or the at least one second video segment for display on a second GUI device in a room in compliance with legal requirements for patient confidentiality, wherein:
the at least one computer is for a medical care entity; and,
generating the video includes:
receiving a second input from personnel of the medical care entity identifying the medical related topic; or,
identifying the medical related topic in response to the patient's identity.

22. The computer-based method of claim 21, further comprising:
accessing electronic medical-related records (EMRRs) for the patient in response to the first input, wherein:
generating the at least one first video segment includes using the EMRRs to identify the first information; or,
generating the at least one second video segment includes obtaining the second information from the EMRRS.

23. A computer-based apparatus for presenting customized medical information, comprising:
at least one computer including:
at least one memory configured to store computer readable instructions; and,
at least one processor configured to execute the computer readable instructions to:
receive a first input identifying a patient;
generate a video including:
at least one first video segment related to a first medical related topic and including first information not subject to legal requirements for patient confidentiality; or,
at least one second video segment related to a second medical related topic and including second information subject to legal requirements for patient confidentiality; and,
transmit the at least one first video segment for display on a first graphical user interface (GUI) device in a room not subject to legal requirements for patient confidentiality; or,
transmit the at least one first video segment or the at least one second video segment for display on a second GUI device in a room in compliance with legal requirements for patient confidentiality, wherein:
the at least one computer is for a medical care entity; and,
generating the video includes:
receiving a second input from personnel of the medical care entity identifying the medical related topic; or,
identifying the medical related topic in response to the patient's identity.

24. The computer-based apparatus of claim 23, wherein:
the at least one processor configured to execute the computer readable instructions to access electronic medical-related records (EMRRs) for the patient in response to the first input; and,
generating the at least one first video segment includes using the EMRRs to identify the first information; or,
generating the at least one second video segment includes obtaining the second information from the EMRRs.
